(19) United States
(12) Patent Application Publication
(10) Pub. No.: US 2026/0350036 A1
(43) Pub. Date: Nov. 5, 2026

(54) SYSTEMS AND METHODS FOR AUTOMATED GEOSPATIAL CORRELATION OF AGRICULTURAL ASSETS AND ASSOCIATED DATA ANALYSIS AND VISUALIZATION

(71) Applicant: International Farming Corporation LLC, Raleigh, NC (US)

(72) Inventor: Gregory Benjamin Somer, Cary, NC (US)

(21) Appl. No.: 19/197,606

(22) Filed: May 2, 2025

(51) Int. Cl. G06F 16/26; G06F 16/22; G06F 16/29; G06Q 10/063; G06Q 50/02

(52) U.S. Cl. CPC G06F 16/26; G06F 16/221; G06F 16/29; G06Q 10/063; G06Q 50/02

(57) ABSTRACT

Systems and methods for aggregating, analyzing, and reporting agricultural data from multiple sources is disclosed. The system enables users to upload, validate, and index various types of agricultural data, including tabular, machine, geospatial, and/or image data. The platform utilizes a centralized asset data model to relate different data types and sources, employing a standardized data indexing model for efficient data retrieval and analysis. Custom analyses and visualizations can be created via a dynamic user interface. The system facilitates data sharing and provides integrated dashboards for comprehensive insights into agricultural operations.

### RELATED APPLICATION(S)

Any and all applications for which a foreign or domestic priority claim is identified in the Application Data Sheet as filed with the present application are hereby incorporated by reference under 37 C.F.R. § 1.57.

### TECHNICAL FIELD

The present technology relates to agricultural data management and reporting systems and methods.

### BACKGROUND

Agricultural data management has traditionally involved various specialized applications and data providers. These systems often operate independently, creating silos of information across different aspects of farming operations. The agricultural industry utilizes a wide range of data types, including financial records, precision agriculture data from farm equipment, geospatial information, and imagery from satellites and drones. This fragmentation of data has made it challenging for stakeholders to gain comprehensive insights into their operations and make informed decisions based on a holistic view of their agricultural data. Thus, new systems and methods for aggregating, correlating, and visualizing agricultural data are needed.

### BRIEF DESCRIPTION OF THE DRAWINGS

Many aspects of the present technology can be better understood with reference to the following drawings. The components in the drawings are not necessarily drawn to scale. Instead, emphasis is placed on illustrating clearly the principles of the present technology. Furthermore, components can be shown as transparent in certain views for clarity of illustration only and not to indicate that the component is necessarily transparent. Components may also be shown schematically.

FIG. 1 is a block diagram showing some of the components typically incorporated in at least some of the computer systems and other devices on which the disclosed system operates in accordance with some embodiments of the present technology.

FIG. 2 illustrates a diagram of an example data hierarchy according to some implementations herein.

FIG. 3 illustrates a table comprising example asset data and location indices according to some implementations herein.

FIG. 4 illustrates a table comprising example asset data including user-provided location indices and categorical indices according to some implementations herein.

FIG. 5 illustrates a table of example asset data including associated temporal data according to some implementations herein.

FIG. 6 illustrates a table of example an asset data structure including a knowledge dating column according to some implementations herein.

FIG. 7A-B illustrate a table of example asset data and an associated category data table linked by a category ID, respectively, according to some implementations herein.

FIG. 8A-B illustrates an example asset data table and curated data table according to some implementations herein.

FIG. 8C illustrates an example analysis data table generated from a combination of the tables in FIG. 8A and FIG. 8B according to some implementations herein.

FIG. 9 is a block diagram showing some of the components typically incorporated in at least some of the computer systems and other devices on which the disclosed system operates in accordance with some embodiments of the present technology.

FIG. 10 is a system diagram illustrating an example of a computing environment in which the disclosed system operates in some embodiments of the present technology.

FIG. 11 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the technology are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### SUMMARY

For purposes of this summary, certain aspects, advantages, and novel features of the present technology are described herein. It is to be understood that not all such advantages necessarily may be achieved in accordance with any particular embodiment of the technology. Thus, for example, those skilled in the art will recognize that the technology may be embodied or carried out in a manner that achieves one advantage or group of advantages as taught herein without necessarily achieving other advantages as may be taught or suggested herein.

Some implementations herein are directed to computer implemented methods for generation of a visualization based on location correlated agricultural asset data. In one embodiment, for example, the method comprises receiving, by a computer system, agricultural data, wherein the agricultural data comprises data relating to a plurality of assets; generating, by the computer system, at least one meta-data table based on the received agricultural data; generating, by the computer system, one or more recommendations for validation rules in connection with the agricultural data, the one or more recommendations based on the at least one meta-data table; validating and normalizing, by the computer system, the agricultural data into one or more normalized asset data tables using the one or more validation rules, wherein the one or more normalized asset data tables comprise: an asset identifier; at least one location index associated with each asset of the plurality of assets, wherein the at least one location index comprises an administrative or agricultural designation of a respective asset of the plurality of assets; and one or more columns comprising asset information corresponding to the respective asset; storing the one or more normalized asset data tables in one or more databases; generating, by the computer system, an analysis data table, wherein the analysis data table comprises a combination of a normalized asset data table of the one or more normalized asset data tables and a selected data table stored in the one or more databases, wherein the normalized asset data table and the selected data table are linked by the at least one location index; and generating, by the computer system, a visualization based at least in part on the analysis data table, wherein the computer system comprises a processor and a memory.

In some implementations, the agricultural data is received via an import mechanism, the import mechanism in communication with a user interface displayed on a user computer system. In some implementations, the agricultural data is imported via an application programming interface (API), wherein the API comprises a Representational State Transfer (REST) API.

In some implementations, the at least one location index comprises a hierarchical set of location indices. In some implementations, the one or more normalized asset data tables further comprise at least one user provided category. In some implementations, the one or more columns comprising asset information comprise at least: full geospatial data a geospatial boundary of each asset of the plurality of assets.

In some implementations, the one or more normalized asset data tables further comprise at least one alternate identifier corresponding to the respective asset of the plurality of assets, wherein the alternate identifier corresponds an identifier of the respective asset in a third-party application. In some implementations, the one or more normalized asset data tables further comprise at least one temporal data column implemented as a Boolean value. In some implementations, the one or more normalized asset data tables further comprise a knowledge date corresponding to each asset of the plurality of assets. In some implementations, the one or more normalized asset data tables further comprise a category identifier for each asset of the plurality of assets, wherein the category identifier links the respective asset to associated records in a separate category-specific data table. In some implementations, the category-specific data table comprises multiple entries for the respective asset, each entry weighted according to an objective criterion.

In some implementations, the method further comprises displaying, via the computer system, the visualization on a user device. In some implementations, the visualization is displayed via a user interface integrated in a mobile application, a web browser, or spreadsheet application.

Some implementations herein are directed to a system comprising at least one hardware processor and at least one non-transitory memory storing instructions that, when executed by the at least one hardware processor, cause the system to: receive agricultural data, wherein the agricultural data comprises data relating to a plurality of assets; generate at least one meta-data table based on the received agricultural data; generate one or more recommendations for validation rules in connection with the agricultural data, the one or more recommendations based on the at least one meta-data table; validate and normalize the agricultural data into one or more normalized asset data tables using the one or more validation rules, wherein the one or more normalized asset data tables comprise: an asset identifier; at least one location index associated with each asset of the plurality of assets, wherein the at least one location index comprises an administrative or agricultural designation of a respective asset of the plurality of assets; and one or more columns comprising asset information corresponding to the respective asset; store the one or more normalized asset data tables in one or more databases; generate an analysis data table, wherein the analysis data table comprises a combination of a normalized asset data table of the one or more normalized asset data tables and a selected data table stored in the one or more databases, wherein the normalized asset data table and the selected data table are linked by the at least one location index; and generate a visualization based at least in part on the analysis data table.

In some implementations, the agricultural data is received via an import mechanism, the import mechanism in communication with a user interface displayed on a user computer system. In some implementations, the agricultural data is imported via an application programming interface (API), wherein the API comprises a Representational State Transfer (REST) API. In some implementations, the at least one location index comprises a hierarchical set of location indices.

In some implementations, the system is further caused to display the visualization on a user device. In some implementations, the visualization is displayed via a user interface integrated in a mobile application, a web browser, or spreadsheet application.

Some implementations herein are directed to non-transitory, computer-readable storage mediums comprising instructions recorded thereon, wherein the instructions when executed by at least one data processor of a system, cause the system to: receive agricultural data, wherein the agricultural data comprises data relating to a plurality of assets; generate at least one meta-data table based on the received agricultural data; generate one or more recommendations for validation rules in connection with the agricultural data, the one or more recommendations based on the at least one meta-data table; validate and normalize the agricultural data into one or more normalized asset data tables using the one or more validation rules, wherein the one or more normalized asset data tables comprise: an asset identifier; at least one location index associated with each asset of the plurality of assets, wherein the at least one location index comprises an administrative or agricultural designation of a respective asset of the plurality of assets; and one or more columns comprising asset information corresponding to the respective asset; store the one or more normalized asset data tables in one or more databases; generate an analysis data table, wherein the analysis data table comprises a combination of a normalized asset data table of the one or more normalized asset data tables and a selected data table stored in the one or more databases, wherein the normalized asset data table and the selected data table are linked by the at least one location index; and generate a visualization based at least in part on the analysis data table.

### DETAILED DESCRIPTION

### Introduction

The existing landscape of agricultural data management is fraught with challenges due to the siloed nature of data across numerous agricultural applications and data providers. This fragmentation often results in widespread utilization of a multitude of data sources and formats, including tabular data (e.g., financials, accounting, and sensor data), machine data from precision agriculture equipment (e.g., combines, tractors, and sprayers), geospatial data from, for example, surveys, insurance maps, soil samples, weather, and water availability, and/or image data from, for example, satellite imagery, drone imagery, and photos. Sharing and utilizing this diverse data in a useful manner is difficult, often requiring agricultural stakeholders to develop their own aggregation and reporting solutions using business intelligence tools, spreadsheets, or custom databases. This process is not only beyond the competency of many users but also extremely time-consuming, hindering efficient data utilization and decision-making.

Furthermore, users of agricultural data span a broad spectrum within the agricultural sector, including farmers and growers, landowners and asset managers, vertically integrated food companies, and supply chain entities. This diverse user base exhibits a wide range of sophistication levels. At the lower end, small farmers with limited resources and technical skills, require easy-to-use and low-cost solutions to manage small data sets, often needing assistance with tools like Microsoft Excel. Moderately sophisticated users, such as large farmers with some technical resources, manage data from equipment, third-party applications, and financials, requiring manual and infrequent updates with several users per account. Finally, sophisticated users such as vertically integrated food companies and large landowners, handle extensive data from equipment, third-party applications, enterprise resource planning (ERP) systems, public data sets, satellites, and drones. These users require application programming interface (API) access, frequent automated data updates, and support for many users per account. The implementations herein are configured to accommodate to the varying needs of these different user groups, providing scalable and adaptable solutions to enhance data management and utilization across the agricultural sector.

As such, the implementations herein are generally directed to systems and methods (generally collectively referred to herein as a “system”) for aggregating, analyzing, and visualizing diverse agricultural data from multiple sources within a unified platform. The system is configured to provide a comprehensive platform designed to consolidate agricultural data from various stakeholders into a single, unified system. The system facilitates easy access to data and visualizations through both web and mobile applications, enabling seamless data retrieval and interaction. Additionally, the system provides access to data via various APIs, enabling integration with other systems and applications. Analytics may be generated and displayed by the system via a dynamic user interface (UI). In some implementations, the UI comprises integrated, easily configurable dashboards and visualizations, allowing users to customize their experience according to specific needs. In some implementations, the system streamlines the management and utilization of agricultural data, enhancing efficiency and decision-making processes for stakeholders.

In some implementations, the system is configured to meet the comprehensive needs of agricultural stakeholders by providing a single, trusted, cloud-based application for aggregating and storing data. This platform may operate on a Data as a Service (DaaS) model, such that users can easily upload, configure, and manage their data through, for example, intuitive web-based wizards. The system comprises various features and visualization tools that facilitate the creation of analyses and visuals, as well as the automation of processes via API access. A standardized data indexing model may be employed to relate imported data geospatially to assets, ensuring that every imported or curated data set is assigned a location index upon import.

The system also supports robust data sharing capabilities, allowing users to share data both within and outside their organizations. In some implementations, common key sets are used to map data, ensuring consistency and interoperability. In some implementations, the system comprises a rich data universe, incorporating application data from sources such as FarmAdvisor (covering assets, agronomy, procurement, and markets) and CropTrak, as well as user-provided data. Additionally, curated data sets from sources like the National Agricultural Statistics Service (NASS), Cropland Data Layer (CDL), Soil Survey Geographic Database (SSURGO), the Internal Revenue Service (IRS), and weather services are integrated to provide comprehensive data coverage.

The UI analytics and dashboards are a core component of the platform, accessible via both web and mobile interfaces, and compatible with spreadsheet applications for further data manipulation and analysis. This multi-faceted approach ensures that users at all levels of sophistication can effectively utilize the platform to enhance their data management, analysis, and decision-making processes.

The description and associated drawings are illustrative examples and are not to be construed as limiting. This disclosure provides certain details for a thorough understanding and enabling description of these examples. One skilled in the relevant technology will understand, however, that the present technology can be practiced without many of these details. Likewise, one skilled in the relevant technology will understand that the technology can include well-known structures or features that are not shown or described in detail, to avoid unnecessarily obscuring the descriptions of examples.

Although certain preferred implementations and examples are disclosed below, inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

The headings provided herein are for convenience only and are not intended to limit or interpret the scope or meaning of the technology.

### System Overview and Data Structures

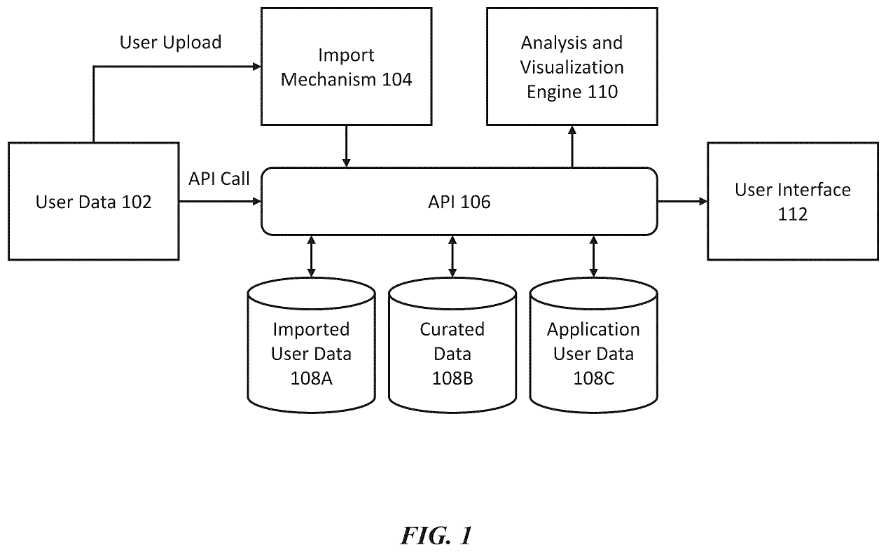

In some implementations, the system incorporates robust data validation and enforcement to ensure data cleanliness and integrity. FIG. 1 illustrates a flowchart of an example data flow of the system according to some implementations herein. In some implementations, user data 102 may be input to the system via one or more data input mechanism such as via upload using import mechanism 104 and/or API 106. In some implementations, the data import mechanism 104 guides users through setting up validation rules during initial data import. The data import mechanism 104 comprises an interface that allows users without extensive technical expertise to set up robust data quality controls. Thus, consistency is maintained across multiple data import sessions and a significantly reduction in the time and effort required for repeated data uploads is achieved.

The data import mechanism 104 may include data validation and enforcement, as the mechanism may guide users through setting up validation rules during the initial data import via the UI. These rules may be implemented with respect to a current import and may also be saved for future data import actions, such that data is handled consistently and efficiently. When data is imported into the system, it undergoes a thorough validation process against the established rules. In some implementations, this validation encompasses several critical aspects of the data structure. For example, column names may be validated to ensure a match with the expected format and nomenclature. Additionally, column types may be verified to confirm that the data in each column aligns with its designated data type. Furthermore, the system evaluates whether required fields are populated and validates nullable fields according to the predefined rules. In some implementations, validation rules may be specified by the user depending on data types and use cases. In some implementations, the system may recommendation a validation rule or automatically generate validation rules.

In some implementations, the data import mechanism 104 may be used to maintain data quality. The data import mechanism 104 may be designed to reject any improperly formed data that does not meet the validation criteria. This strict enforcement prevents the introduction of poor data or duplicate entries that could potentially corrupt the dataset. By implementing these rigorous validation measures, the system may maintain a clean and reliable data repository.

To facilitate automated data management, the system may also comprise an API 106, including, for example, a Representational State Transfer (REST) API endpoint. A REST API endpoint is a specific uniform resource locator (URL) or uniform resource identifier (URI) that accepts web-based API requests and provides access to resources or services within a system using REST principles. In some implementations, API 106 leverages AWS API Gateway combined with Lambda or Fargate services, while incorporating Apache Spark and/or Python for the processing layer.

In the context of the system, the endpoint enables programmatic data upload and retrieval, allowing for seamless integration with external systems and automated workflows. Users can leverage this API 106 to automate routine data import tasks, schedule regular data updates, and retrieve data for analysis or reporting purposes, all while benefiting from the same validation and enforcement rules applied through the user interface. Thus, the API 106 serves as an interface for automated data upload and retrieval. The API 106 allows external applications or scripts to programmatically interact with the system. For example, external applications can send HTTP POST requests to the API 106 with properly formatted data payloads to import new data into the system. Additionally, applications can make HTTP GET requests to fetch data from the system, potentially with query parameters to filter or specify the desired information. In addition, in some implementations, the API 106 enables the creation of automated workflows for regular data updates, synchronization with other systems, or scheduled data exports. In some implementations, data submitted through the API 106 undergoes the same validation rules and checks as data imported through import mechanism 104, ensuring data integrity across all input methods.

In some implementations, the data from import mechanism 104 and/or API 106 is stored in one or more databases, such as an imported user data database 108A, curated data database 108B, and/or application user data 108C. Generally, imported user data database comprises data that is directly provided by users of the system. This could include various types of agricultural information such as financials, plantings, yields, and soil samples. Users can upload this data through different interfaces such web applications, mobile apps, or spreadsheets using the data import mechanism 104. Curated data database 108B may comprise large public datasets. The system may process and standardize this data to make it easily accessible and compatible with user-provided data. In some implementations, application user data database 108C may comprise data from integrated applications. This data may be generated or collected by these applications as users interact with them in their day-to-day agricultural operations and may automatically imported to the system using API 106. The one or more databases described above may form a data lake or data warehouse accessible by analysis and visualization engine 110 through, for example API 106.

Once received, uploaded files may enter a sophisticated staging area where they undergo comprehensive processing. This staging process may include multiple validation steps based on rules defined in a meta-data at table creation. In some implementations, the system can perform complex validations, including cross-referencing against external datasets. For example, the system can verify that values in certain columns exist within specified reference datasets for data integrity across related information. Furthermore, the system may implement a comprehensive set of data transformations, also defined in the meta-data, for consistency in data formatting. Text transformations may follow a specific sequence of operations: converting to lower case, trimming white space from the ends, and removing multiple white spaces within the text. For example, a string like “Little red Riding hood” may automatically be transformed to “little red riding hood”. In some implementations, column name standardization automatically normalizes column names to lower case with underbars, ensuring consistent naming conventions regardless of the input format. For instance, variations like “Crop Price,” “crop price,” “Crop price,” and “crop-price” may all be standardized to “crop_price”. This normalization simplifies data integration and reduces potential errors in data access and analysis. In some implementations, data type conversion is handled automatically, such that the system can intelligently convert between different data types while maintaining data integrity. For example, numeric values stored as text (“123”) or integers (123) can be automatically converted to floating-point numbers (123.0) when required by the schema.

After processing, the system may save the processed staging files in s3 storage, which may be upserted (inserted or updated as appropriate) into the user data table. The upload process may conclude with the generation of a detailed transaction record with comprehensive feedback about the upload operation. The transaction record may comprise includes both an overall error/success message indicating the status of the upload and a detailed CSV file containing validation status information for each processed row. This detailed feedback enables users to quickly identify and address any issues that may have occurred during the upload process.

In some implementations, analysis and visualization engine 110 processes the validated data to generate data insights and visual representations. As such, analysis and visualization engine 110 serves to transform the data stored in the one or more databases into actionable information for users. In some implementations, an analysis component of the engine 110 applies various analytical processes to the integrated data from multiple sources, including user-provided data, curated data, application data, and data services. The engine 110 may comprise statistical methods, artificial intelligence (AI)/machine learning (ML) algorithms, and other data processing techniques to uncover patterns, trends, and correlations within the agricultural datasets.

In some implementations, a visualization component of the engine 110 may utilize the results from the analysis and render the results into comprehensive visual formats. This includes generating a variety of visual elements, including charts, graphs, maps, and dashboards. The system may support both web and mobile interfaces, as well as interfaces compatible with various third-party applications. In some implementations, engine 100 comprises a plurality of tools for users to create custom analyses and visuals without requiring deep technical expertise. The system also supports the creation of integrated dashboards, allowing users to combine multiple data visualizations into a single, comprehensive view.

In some implementations, the engine 100 interfaces with the API 106, enabling automated generation and retrieval of analyses and visuals. Furthermore, the engine may integrate with external systems to support more sophisticated users who may want to incorporate analyses into their applications or workflows. In some implementations, the engine 100 interfaces with a UI 112 and/or various front-end applications and/or analytics tools, such as web application interfaces, BI Tools, or custom dashboards, which may be built into the UI.

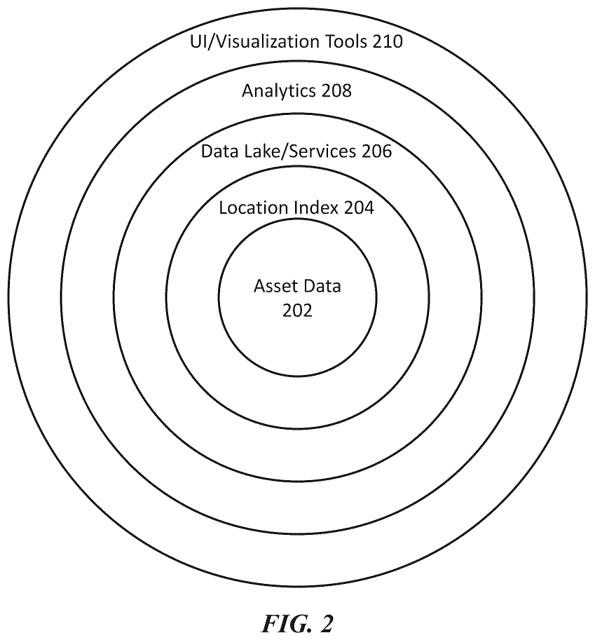

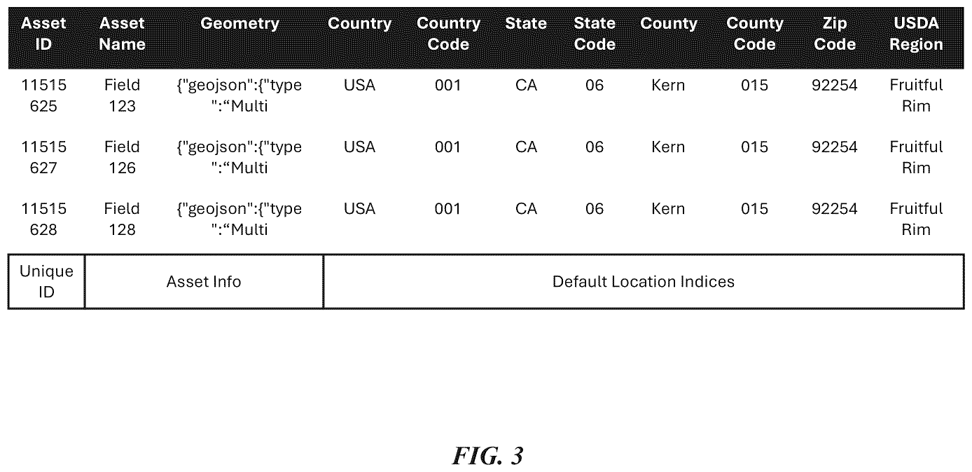

FIG. 2 illustrates a diagram of an example data hierarchy according to some implementations herein. In some implementations, the data hierarchy comprises a layered structure. At the foundation of this structure is asset data 202, forming the core around which all other data types are organized. Asset data 202 serves as the central reference point to which all other data types are related through location indices 204. Asset Data 202 may primarily comprise information about specific agricultural assets such as fields, wells, and other physical properties. In some implementations, each asset is assigned a unique asset identifier (ID), which acts as the common identifier for relating the asset to other data within the system. In some implementations, the asset data may include several components. For example, asset data 202 may comprise asset information including asset name, asset type, geometry (e.g., GeoJSON format for spatial representation), centroid coordinates, and area measurements. FIG. 3 illustrates a table comprising example asset data 202 and location indices 204 according to some implementations herein.

In some implementations, asset data 202 is structured using a simple flat schema, which provides a straightforward and efficient method for organizing and accessing critical information. In some implementations, this schema is composed of two main categories: default configuration data and user provided data.

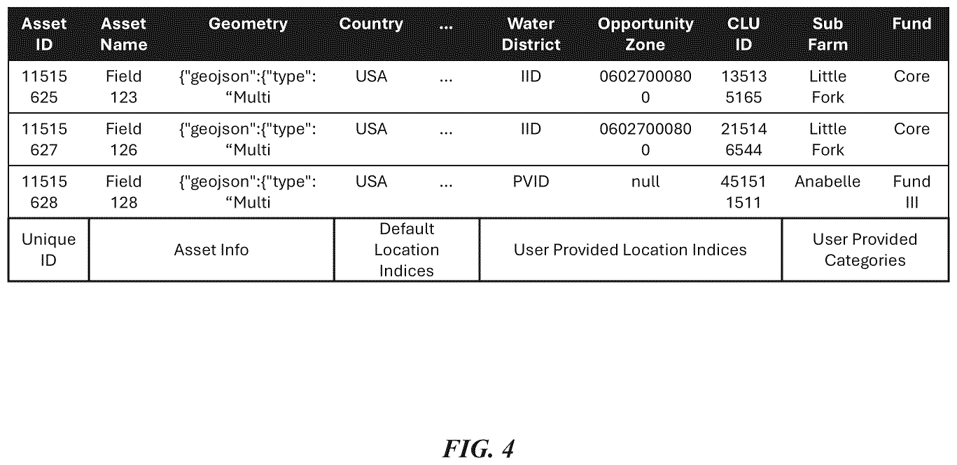

FIG. 4 illustrates a table comprising example asset data 202 including user-provided location indices 204 and categorical indices according to some implementations herein. In some implementations, default configuration data comprises a comprehensive set of location indices 204 that provide a multi-layered approach to geographically situating each asset. In some implementations, at the core of the schema is the Asset ID, a globally unique identifier that serves as the primary key for each asset record. In some implementations, a property ID offers an additional level of identification, grouping related assets together. In some implementations, the schema also incorporates a hierarchical set of geographical identifiers, starting with, for example the asset country and drilling down through state, county, and municipality. Each of these levels may be represented by both a Federal Information Processing Standards (FIPS) code and its corresponding name. In some implementations, the zip code and/or postal provides another common geographical reference point, while the USDA Region situates the asset within broader agricultural zones. A special “None” index may be included for utility data such as mapping tables, allowing for flexible data relationships outside the standard geographical hierarchy. The schema is configured to allow for additional indices to be defined as needed.

In some implementations, complementing the location indices 204, the default configuration data also comprises descriptive data that provides essential characteristics of each asset. For example, this descriptive data, also called asset information, includes the asset name, asset type to categorize the nature of the asset (e.g., field, well, storage facility), and/or asset geometry, which may include the full geospatial data defining the asset's boundaries. In some implementation, an asset centroid pinpoints a central reference point for the asset, while an asset area quantifies the size of the asset. As with the location indices 204, the schema may allow for additional descriptive fields to be added as required.

In some implementations, the user provided data of the schema allows for customization and extension of the asset data structure to meet specific user needs. For example, users can define their own location indices 204, enabling users to situate assets within custom-defined geographical or administrative boundaries that may be relevant to their operations. These custom indices may be derived from various sources, such as user-provided geospatial files or mapping files. This flexibility in the schema allows users to incorporate location-based data that is specifically relevant to their operations, such as custom-defined growing regions, microclimate zones, or proprietary land classification systems. The system may define and/or calculate these custom location indices 204 at the time of asset import, such that that new assets are immediately integrated into the user's custom geographical framework. The location indices 204 may also be redefined/recalculated during any subsequent updates to the asset data 202.

Furthermore, in some implementations, the extensible schema supports user-defined categorical indices. These indices allow users to classify and group assets based on criteria that are meaningful to their specific operations or analytical needs. Like the location indices, categorical indices may be calculated from user-provided mapping files. These categorical indices may include classifications based on crop rotation cycles, soil types, irrigation methods, or any other user-defined criteria that aids in asset management and analysis.

The schema also accommodates alternate IDs, such that users can maintain links to external or legacy identification systems. This feature further integrates the system with existing farm management software, historical databases, and/or industry-specific identification schemes. As such, the system facilitates seamless data integration and cross-referencing, maintaining continuity with established data management practices.

Additionally, the extensible schema may support the integration of specialized or proprietary data sets that may be crucial to a particular user's operations. For instance, a user could incorporate custom soil classification systems, proprietary crop variety identifiers, or specialized land use designations that are not part of standard agricultural data sets.

This simple, flat, and extensible schema approach for asset data 202 offers several advantages over existing systems. For example, the combination of standardized default configuration data with user provided data provides both consistency and customization options. Furthermore, this structure allows for efficient querying and analysis of asset data 202, while also supporting the diverse needs of different users within the agricultural sector. The flat nature of the schema contributes to performance benefits in data retrieval and updates, which is critical for a system designed to handle large volumes of agricultural data across numerous assets.

In some implementations, the asset data 202 structure may also comprise an effective dating configuration for tracking and managing changes to asset information over time. This temporal data management system employs a set of specialized columns that enable precise historical tracking while maintaining clear records of current asset states.

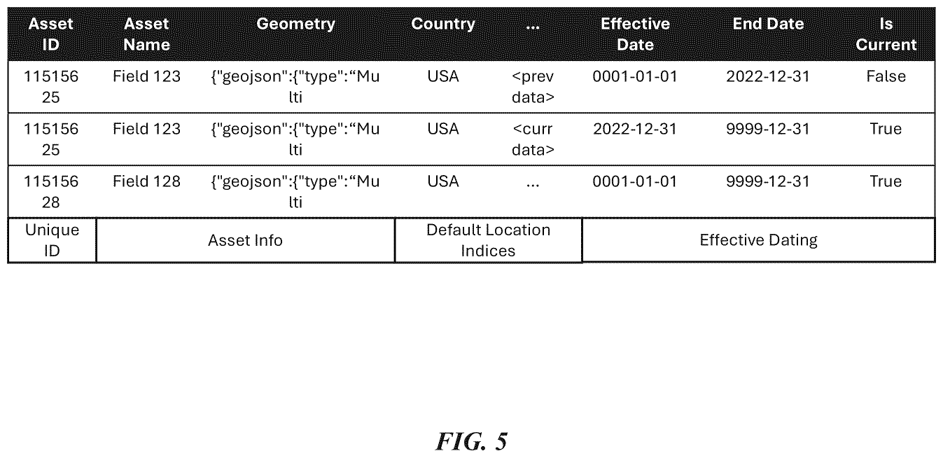

FIG. 5 illustrates a table of example asset data 202 including associated temporal data according to some implementations herein. In some implementations, the system several components for tracking temporal data. In some implementations, an effective date column may be utilized, which implements a greater-than-or-equal-to (>=) comparison to determine when a particular record becomes current. For example, the system may establish a universal starting point by using ‘0001-01-01’ as the first record start date, such that all historical records can be properly anchored in time. Thus, the system maintains complete historical records from the beginning of an asset's existence in the database. The data structure may also comprise an end date column, which may use a less-than (<) comparison to determine when a record's validity expires. In some implementations, the system may employ ‘9999-12-31’ as the end date for current records, effectively marking them as valid indefinitely until superseded by newer information. This approach ensures that current records can be easily identified while maintaining the flexibility to add future-dated changes when needed. In some implementations, the data structure also comprises a current flag, implemented as a Boolean value. The current flag may comprise a simple true/false indicator that a quick and efficient way to identify the currently active record for any given asset. This flag may be particularly useful for queries that need to quickly access the current state of assets without performing more complex date comparisons.

The effective dating structure enables several powerful capabilities within the system. As noted above, the effective dating structure enables users to track the complete history of changes to asset information, view the state of assets at any point in time, and maintain accurate current records while preserving historical data. The system can efficiently handle scenarios such as planned future changes, historical analysis, and audit trails of asset modifications. This temporal awareness is crucial for agricultural operations where understanding the historical context and evolution of assets can provide valuable insights for decision-making and planning. Furthermore, the implementation of this effective dating system facilitates data integrity and enhanced query performance. By using standardized date boundaries and Boolean indicators, the system can efficiently handle temporal queries.

In some implementations, the system's asset data 202 structure also comprises a knowledge dating component, representing an advanced approach to tracking not just when data changes occurred, but when those changes became known to users. This temporal awareness system distinguishes between the timing of events and the timing of knowledge acquisition.

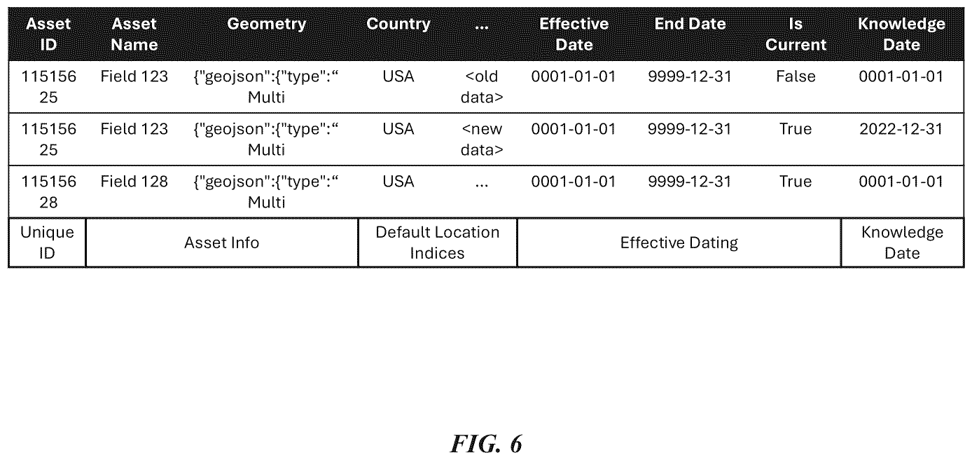

FIG. 6 illustrates a table of example an asset data 202 structure including a knowledge dating column according to some implementations herein. In some implementations, the system implements this functionality through a dedicated knowledge date column, which records the specific date when information became known to the user. This timestamp is distinct from the effective dating system and serves a different purpose. Rather than tracking when changes become valid, the column tracks when users became aware of or recorded the information. This distinction is critical for agricultural operations in which the timing of knowledge acquisition can be as important as the timing of the events themselves. This feature enables powerful historical analysis capabilities by allowing users to reconstruct what was known at any given point in time. For example, users can analyze decision-making processes by understanding what information was available when certain choices were made, regardless of when the underlying events occurred. In addition, in some implementations, the knowledge dating system works in conjunction with the effective dating system to provide a comprehensive temporal view of asset data. While effective dating tracks when changes are valid, knowledge dating tracks the evolution of understanding about those changes. This dual temporal tracking enables sophisticated analysis of both the actual timeline of events and the timeline of information availability.

As noted above, asset data 202 may be related to other data types of the system through location indices 204. Location indices 204 may comprise various administrative and agricultural designations, including for example, country, state, county, city, zip code, USDA region, and/or other relevant agricultural or water districts. In some implementations, the system allows for multiple location indices 204 to be associated with each asset within asset data 202, enabling flexible data relationships and analysis across different geographical and administrative boundaries. In some implementations, the location indices 204 may be continuously and automatically updated, such that assets can be accurately related to both asset specific and non-asset specific data.

In some implementations, the system's asset data 202 structure provides features to handle complex relationships between assets and their associated categories. These features specifically address the common agricultural scenario where a single asset needs to be associated with multiple categorical entries, implementing a “one-to-many” relationship structure that maintains data integrity while providing flexible categorization options. In some implementations, the system implements this relationship through a carefully designed table structure. In some implementations, the asset data 202 table contains a category ID field that serves as a unique identifier linking to associated records in separate category-specific tables. This approach allows for efficient organization of complex relationships while maintaining data normalization. Rather than storing all category information directly in the asset data 202 table, this structure uses the unique identifier to maintainable relationships between assets and their various categorical associations.

For example, in the handling of tax parcels, a single block (asset) might encompass multiple tax parcels, creating a complex relationship that needs to be accurately tracked and managed. The system may handle this scenario by storing a unique parcel ID in the asset data 202 table for each asset row entry. The parcel ID serves as a pointer to a parcel table, where multiple entries can exist for each parcel ID, effectively managing the one-to-many relationship between blocks and their constituent tax parcels.

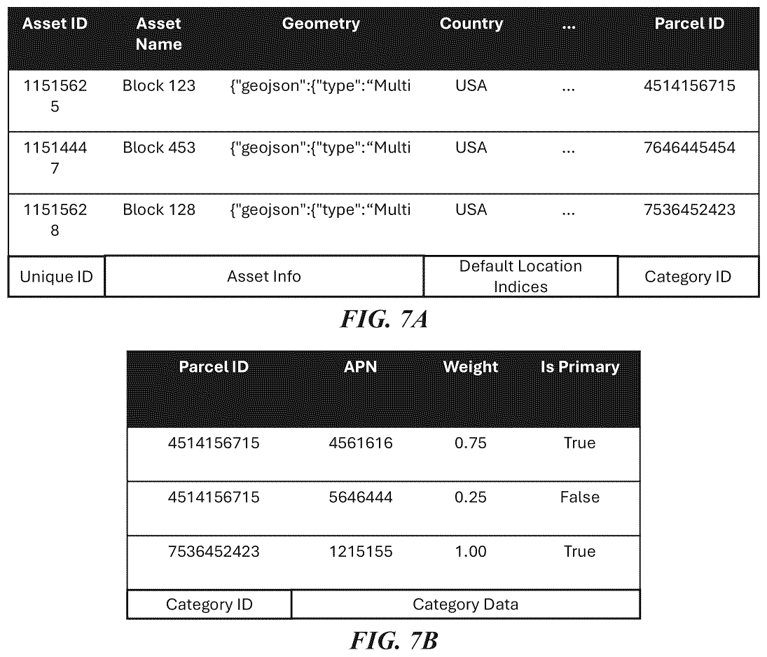

In some implementations, the system also incorporates a weighting mechanism for these relationships. For example, weights can be calculated automatically based on objective criteria such as parcel area, or they can be manually assigned by users to reflect other important factors. This weighting system is particularly useful for aggregations and analyses that need to account for the relative importance or contribution of different categorical elements to the overall asset. In some implementations, this data structure enables accurate tracking of complex asset-category relationships while maintaining data integrity and avoiding redundancy. The weighting system allows for nuanced analysis that takes into account the relative significance of different categorical elements. FIG. 7A-B illustrate a table of example asset data 202 table and an associated category data table linked by a category ID, respectively, according to some implementations herein.

In some implementations, surrounding the central asset data 202 are one or more distinct categories of data lake/data services 206, including, for example, user provided data, curated data, application data, and data services. In some implementations, as described with respect to FIG. 1, user provided data includes information directly input by system users, such as, for example, financials, yields, and soil samples. This category also includes critical agricultural data and planting data, including details on crop types, planting dates, and acreage allocated to different crops. Yield data provides information on crop production, including harvest dates, quantities, and quality metrics. Soil sample data comprises information including soil health and composition, which is vital for making informed decisions about fertilization and crop selection. In some implementations, as described with respect to FIG. 1, users can import this data through various interfaces, including web applications, mobile apps, and spreadsheets, with the data import mechanism. The data layer implementation may include multiple configuration options to accommodate various deployment scenarios. For example, these include a serverless data lake approach utilizing, for example, Amazon S3 storage combined with Delta Lake and AWS Athena or Presto for query processing. Alternatively, the system supports a traditional data lake and warehouse configuration combining S3 storage with a hybrid SQL/NoSQL database structure.

In some implementations, the system employs a sophisticated meta-data management structure that serves as the foundational framework for organizing and maintaining user data relationships and validation rules. This comprehensive meta-data architecture provides consistency, accuracy, and efficient data integration in the system.

In some implementations, the meta-data table functions as a central repository for storing schema definitions and attributes for each dataset within the system. The meta-data table captures essential information including the data name for identification, column names and their associated types, and specific data mappings that define relationships between different data elements. The table also stores the location index type, along with data validation rules. Data set mappings define how different datasets relate to each other, while source file references maintain links to original data sources. In some implementations, certain elements of the meta-data tables may be generated by the system and other parts may be generated by the user. For example, the user may specify the primary keys and column names, among other. In some implementations, the system may generate descriptive statistics about the data contained in each column. In some implementations, the meta-data tables may also store a text description and descriptive statistics of the data set such that an AI/ML engine can index the underlying table and retrieve relevant data for analysis.

In some implementations, the system implements meta-data creation through an automated interface. For example, when users import new user data, the automated interface and the system completes the complex task of generating appropriate meta-data records. This process may require users to either answer questions or provide a data sample that the system can analyze to determine the appropriate schema and meta-data structure. This significantly reduces the technical burden on users while ensuring that meta-data is created correctly. In some implementations, a meta-data management system manages the meta-data such that users never interact directly with the meta-data itself. Instead, the system operates that meta-data tables automatically and independently, automatically managing data imports and facilitating the combination and/or joining of user data with asset data 202. This abstraction protects the integrity of the meta-data structure while allowing users to focus on their data analysis and visualization needs rather than technical database management tasks.

Curated data comprises, for example, large-scale datasets that are maintained and provided by the system to users. These datasets may typically be sourced from public repositories and are processed to integrate seamlessly with the system. Examples include USDA NASS (National Agricultural Statistics Service) data, which offers comprehensive agricultural statistics at national, state, and county levels. The Cropland Data Layer (CDL) provides detailed spatial information on land cover and crop types across the United States. SSURGO (Soil Survey Geographic Database) data offers detailed soil information. By incorporating these curated datasets, the system provides users with access to valuable contextual information that can enhance their decision-making processes without requiring them to source and process this data independently.

Application Data may originate from integrated software solutions that are part of the system ecosystem. This includes data from FarmAdvisor, which provides farm management and decision support information, CropTrak, which provides crop monitoring and traceability data, and enterprise resource planning (ERP) system data, which could encompass a wide range of operational information, including inventory management, supply chain data, and financial transactions. This category of data may be generated as users interact with these applications in their day-to-day agricultural operations, providing a dynamic and up-to-date view of various aspects of farm management.

Data services represent external data sources that are accessed through the API(s) to provide additional context and insights. The FRED (Federal Reserve Economic Data) service, for example, may provide macroeconomic indicators that may impact agricultural markets and decision-making. Weather services provide data on current conditions, forecasts, and historical weather data for agricultural planning and risk management. Other services such as NetSuite may also be integrated. In some implementations, these data services allow the system to incorporate real-time or regularly updated information from specialized providers.

In some implementations, a data catalogue serves as a comprehensive inventory of all available datasets within the system. This data catalogue leverages the meta-data structure to provide users with visibility into available data resources. The catalogue provides users with searchable access to dataset descriptions, relationships, and usage information, all derived from the underlying meta-data structure.

In the example of FIG. 2, encircling these data segments is analytics layer 208. Analytics layer 208 may serve as a critical component intermediary step between raw data input and visual output. In some implementations, the analytics layer 208 processes and analyzes the diverse data types collected from the various data sources to generate meaningful insights for users and prepare information for visualization. Analytics layer 208 may be configured to handle data from multiple sources and of differing types, including the user provided data, curated data, application data, and data services. Analytics layer 208 may integrate these disparate data types, using asset data 202 as the common thread to relate the different pieces of information. This integration allows for comprehensive analysis that considers a wide range of factors affecting agricultural operations.

In some implementations, analytics layer 208 may be configured to create analysis data sets. These are combinations of one or more data sets from data lake/data services 206 that create data tables specifically for analysis and visualization. The system allows users to configure these analysis data sets through the dynamic UI. For example, users can select which data to join, preview the joined data, create calculated columns (e.g., Revenue=Yield×Price), and apply filters and groupings to refine the analysis. In some implementations, analytics layer 208 supports the creation of derived columns, allowing users to perform calculations and transformations on the data. This feature enables the generation of new insights by combining or manipulating existing data points. For example, users might create a profitability metric by combining yield data with price information and production costs. To optimize performance, in some implementations, the analytics layer 208 converts analysis data sets into various views once they are defined. This approach may improve read performance for frequently accessed analyses. The system may also materialize these views if needed, further enhancing performance for complex or frequently used analyses.

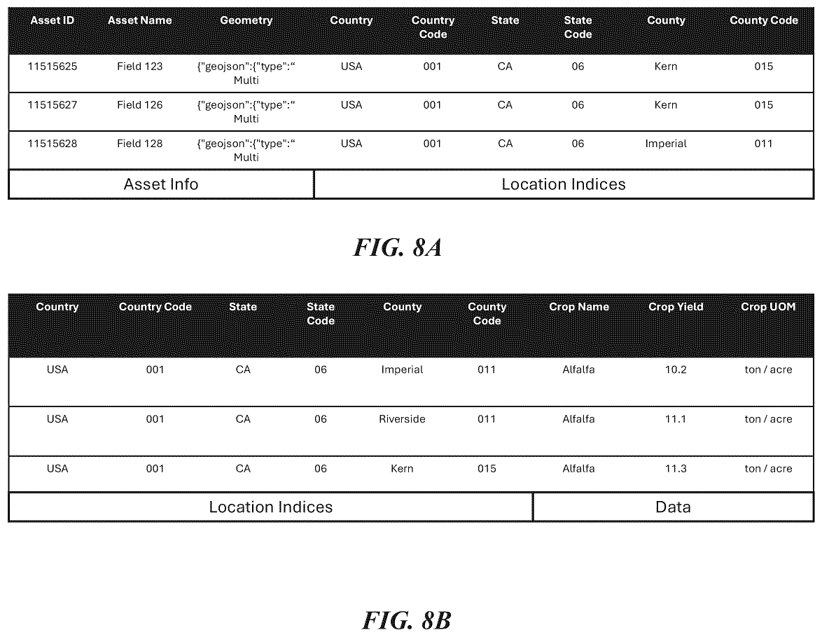

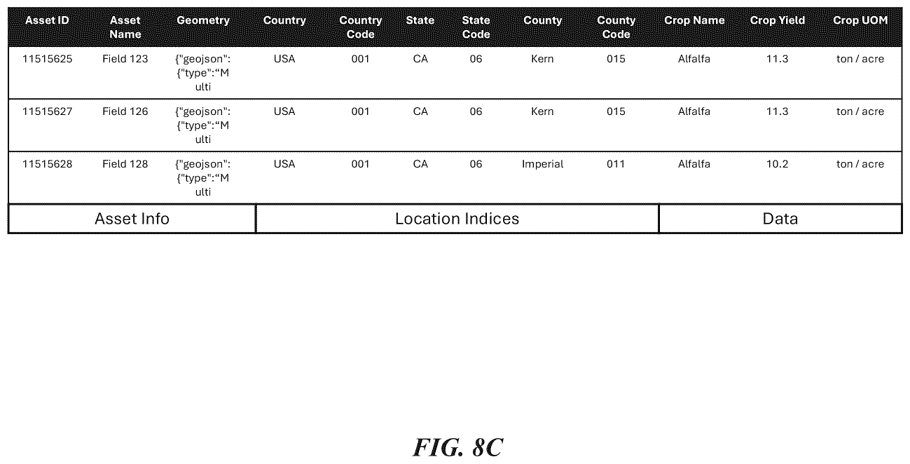

With analysis data tables, the system may be configured for the creation of enriched analytical datasets through the combination of multiple data sources. FIG. 8A-B illustrate an example asset data table and curated data table, respectively, according to some implementations herein. FIG. 8C illustrates an example analysis data table generated from a combination of the tables in FIG. 8A and FIG. 8B according to some implementations herein. This combinatorial approach allows users to bring together various types of information to create comprehensive data tables that serve both analysis and visualization needs. In some implementations, central to the analysis data table architecture is its relationship with asset data 202, which may serve as the primary hub for all data joins. This hub-and-spoke model facilitates consistent and reliable data relationships by channeling all connections through the asset data 202 structure. In some implementations, the joining mechanism operates through assigned location indices, providing a standardized approach to relating different data sets.

In some implementations, analytics layer 208 is configured to handle both asset specific data and non-asset specific data. For asset specific data, such as asset data 202, which is directly associated with assets, the analytics layer 208 can provide detailed insights into individual asset performance. For non-asset specific data, such as regional climate data or market trends, the analytics can relate this information back to specific assets through location attributes or geospatial intersection, providing broader context for asset-specific analyses. The system's analytics layer 208 capabilities include various types of analyses, from aggregations and statistical calculations to potentially more complex modeling and predictive analytics, as well as ML/AI-powered analysis. In addition, analytics layer 208 supports advanced analytical techniques such as trend analysis, correlation studies, and ML algorithms for predictive modeling. Furthermore, analytics layer 208 is configured to work in conjunction with the system's API(s), allowing for automated generation and retrieval of analyses. This enables further integration with external systems and supports more sophisticated users who may want to incorporate the system analyses into their own applications or workflows.

Regarding non-asset specific data, which encompasses information that pertains to broader geographical regions and lacks direct asset linkage, including comprehensive datasets such as USDA NASS statistics, CDL information, and SSURGO soil surveys, these datasets may not maintain direct asset relationships. In some implementations, the system provides sophisticated mechanisms to relate this information back to specific assets through either location attributes (such as county or state designations) or through geospatial intersection calculations. Furthermore, the system may handle non-asset specific Data through a specialized approach via the analytics layer 208. The analytics layer 208 may facilitate the joining of non-asset specific information back to asset data 202, enabling integrated analysis and visualization. The system may accommodate both vector and raster data formats, whether in single files or tile sets, providing comprehensive support for various spatial data types. In the meta-data, non-asset specific data may be distinctly marked with a Location Index set to ‘None’, clearly differentiating it from Asset Specific Data, but maintaining clear organizational principles.

In some implementations, the system employs a configuration mechanism of the UI that streamlines the setup process for analysis data structures. This approach guides users through several steps in creating analytical views. For example, users can easily select the user data to combine, preview the combined dataset before finalizing the configuration, and create custom calculated columns for derived metrics. The configuration mechanism may also enable users to establish filters and groupings to provide precise control over data analysis parameters.

The outermost ring of the example hierarchy is UI/Visualization Tools 210, representing the final output stage where processed data is transformed into visual representations for user consumption. UI/Visualization Tools 210 are designed to provide an interactive and user-friendly interface for exploring and understanding complex agricultural data. For example, the system supports a variety of visualization types to cater to different data representation needs. These include layers in maps, which can be integrated with services like Mapbox, allowing for geospatial visualization of data. Modal popups provide a mechanism to display detailed information about specific data points or assets when interacted with on a map or chart. Dashboards offer a comprehensive view of multiple data visualizations in a single interface.

The system's visual generation capabilities may be built directly from analysis data. The system is configured for native visual building functionality, allowing users to create visualizations that can be either viewed directly within the system or embedded into external web applications. Access to visualization data may be facilitated through the REST API to create specialized visual implementations. The system may support multiple visualization types including map-based visualizations, where data can be displayed as layers within mapping platforms such as Mapbox through REST API calls.

For users that prefer to work with familiar tools, in some implementations, the system includes various add-ins, such as an Excel Add-in. which enables users to access and visualize data directly within Microsoft Excel or other spreadsheet applications. In some implementations, the system also integrates directly with mobile device applications and/or browsers, with support for data visualization in third-party mobile applications. In some implementations, for more advanced users or those with specific visualization needs, the system provides access to analysis layer data 208 via the REST API. This allows for custom development of visualizations, giving users the flexibility to create bespoke visual representations of their data using tools of their choice.

In some implementations, UI/Visualization Tools 210 include mechanisms for creation of dashboards, which allow users to combine multiple visualizations into a coherent and comprehensive view. The UI for creating and customizing visualizations includes drag-and-drop functionality for arranging dashboard components, point-and-click options for selecting data series to visualize, and controls for adjusting visual properties like colors, scales, and labels. In some implementations, the system supports the creation of comprehensive dashboards through the combination of multiple analysis data sets. This capability is enhanced by a dashboard control group feature, which implements global filters that can be applied across multiple data queries and aggregations.

Performance optimization is achieved through the system's view-based architecture. Once defined, analysis data may be automatically converted into a view structure, enhancing read performance for frequent data access operations. The system includes provisions for materializing these views as needed. In some implementations, UI/Visualization Tools 210 also comprise interactive elements. For example, in some implementations, user can hover over data points for more information, click to drill down into more detailed views, and use sliders or dropdown menus to adjust time ranges or filter criteria.

### AI/ML Integration and Technical Advantages

In some implementations, UI/Visualization Tools 210 includes AI/ML based interfaces such as text and voice interface functionality, enabling users to query data through natural language interactions. Furthermore, the system may be configured to support automated analysis generation, streamlining the creation of complex analytical outputs. Additionally, the architecture may support automated visual generation capabilities, enabling AI-driven creation of data visualizations that respond to user needs and data patterns.

In some implementations, the architectural foundation for AI integration is established through the meta-data schema structured to support AI operations, as data relationships and attributes are clearly defined and accessible for ML applications.

The system may leverage existing operational and agronomic data, particularly from large customers in the CT system, providing a rich dataset for AI development and testing. The architecture includes integration with sophisticated tools like Data Bricks, and maintains Delta Lake compatibility, ensuring that the system can leverage advanced data processing and AI capabilities as they evolve.

In some implementations, the system may utilize one or more AI/ML models. As used herein, the term “model” can include any computer-based models of any type and of any level of complexity, such as any type of sequential, functional, or concurrent model. Models can further include various types of computational models, such as, for example, artificial neural networks (“NN”), language models (e.g., large language models (“LLMs”)), AI models, ML models, multimodal models (e.g., models or combinations of models that can accept inputs of multiple modalities, such as images and text), and/or the like.

In various implementations, the one or more models of the present disclosure may be locally hosted, cloud managed, accessed via one or more Application Programming Interfaces (“APIs”), and/or any combination of the foregoing and/or the like. Additionally, in various implementations, the one or more models of the present disclosure may be implemented in or by electronic hardware such as computer processors.

Examples of foundation models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (Large Language Model Meta AI), BigScience Large Open-science Open-access Multilingual Language Model (BLOOM), and Mistral.

In some implementations, training of the one or more models is supervised, semi-supervised, unsupervised, self-supervised, or a combination of one or more of the above. In some implementations, other forms of machine learning types are utilized, including reinforcement learning, transfer learning, multi-task learning, meta-learning, and/or federated learning. Furthermore, training of the one or more models may be continuous and/or periodic. In some implementations, the one or more models are trained continuously using self-supervised learning, such that the one or more models are automatically and continuously updated without human intervention. In some implementations, the one or more models may be periodically trained with newly ingested real-world data from deployed instances of the one or more models.

In some implementations, the system comprises a dynamic user interface, such as a natural language interface fine-tuned for interactions with, for example, embedded charts, tables, and attachments.

The system advantageously overcomes various technical challenges of agricultural data management and integration. Managing agricultural data often involves dealing with siloed data across many agricultural apps and data providers, making organization and analysis difficult. The system comprises a centralized data platform that handles multiple data types including tabular data (financials, accounting, sensor data), machine data (precision Ag Data from combines/tractors/sprayers), geospatial data (surveys, insurance maps, soil samples, weather, water availability), and image data (satellite imagery, drone imagery, photos). The system uses a sophisticated meta-data framework and location indexing model to relate imported data geospatially to assets. Additionally, the data platform can be enhanced through user-provided data and automated data uploads to further expand the system's analytical capabilities.

Furthermore, a key aspect of agricultural data management is enabling analysis across diverse data sources. However, analyzing data across multiple sources and formats is time and resource-intensive with existing tools. The system's comprehensive data platform and integration with existing agricultural applications, along with sophisticated data validation and transformation algorithms, allows for efficient and automated processing of both asset-specific and non-asset-specific data to enable meaningful analysis.

The system also advantageously addresses the challenges of data validation and standardization in agricultural operations. All analysis relies heavily on clean, validated data. In agricultural operations, managing data quality is extremely difficult due to varying data formats and sources. The system addresses these challenges through automated data validation rules set up at initial import, ensuring proper column names, types, and required fields. The system's data validator rejects improperly formed data, preventing bad or duplicate data from corrupting the dataset while enabling automated data upload and retrieval through REST API(s).

In addition to data quality challenges, existing agricultural solutions often lack integration capabilities with other farm management tools and systems. The system overcomes this through a sophisticated API architecture using, for example, AWS API Gateway with Lambda or Fargate, combined with Apache Spark and/or Python for the processing layer. This enables seamless integration with existing enterprise systems while maintaining high performance and scalability.

The present disclosure further includes various processes, functionality, and interactive user interfaces related to the system. According to various implementations, the system can advantageously manage and analyze complex interactions between various agricultural data sources through its analysis data framework. The system enables creation of derived columns, data joins through location indices, and sophisticated visualization capabilities including map layers, modal popups, and dashboards.

Various implementations of the system provide improvements to agricultural technologies, enhancing capabilities across multiple domains. For example, the system provides precise agricultural data analysis through its asset data framework, which serves as the foundation for all analysis and visualizations. The computational architecture allows for handling thousands of users and many data types while maintaining fast read performance through materialized views. Other technical benefits include support for effective dating and knowledge dating of asset changes, enabling historical tracking of what was known at specific times. Furthermore, the system facilitates seamless data integration by supporting multiple entries with categories and sophisticated location indexing.

By automating data validation, transformation, and integration processes, the system significantly reduces the manual effort required to manage agricultural data. The system analyzes vast datasets while maintaining data integrity through sophisticated validation rules and transformation processes, enabling users to combine and analyze data from multiple sources with unprecedented efficiency.

Additionally, implementations of the system are inextricably tied to computer technology. Various implementations rely on advanced computational capabilities through multiple data layer configurations: a serverless data lake architecture, or a traditional data lake and warehouse approach with hybrid database structures. These architectural options are implemented through cloud computing platforms, enabling the system to efficiently handle data sets of all sizes.

Various implementations of the present disclosure provide improvements to agricultural data management technologies through sophisticated data validation, transformation, and integration capabilities. The system's implementation is fundamentally tied to computer technology through its cloud-based architecture and API framework. Features such as automated data validation, location-based data joining, and sophisticated visualization capabilities cannot be performed by humans alone, requiring the computer technology upon which they are implemented. Further, the implementation enables many advantages including efficient handling of diverse agricultural data types and automated data quality management without manual intervention.

### Computer System

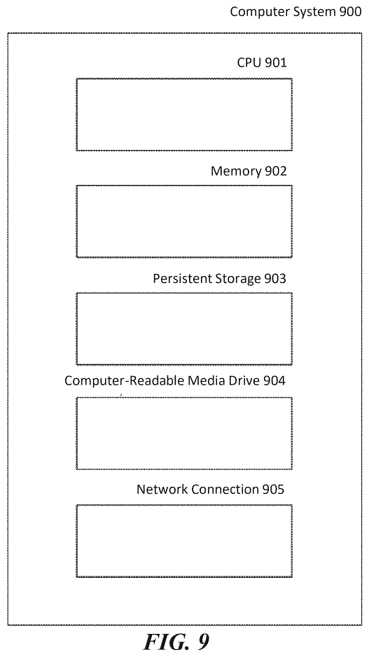

FIG. 9 is a block diagram showing some of the components typically incorporated in at least some of the computer systems and other devices on which the disclosed system operates. In various embodiments, these computer systems, and other devices 900 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (CPU) 901 for executing computer programs; a computer memory 902 for storing programs and data while they are being used, including the facility and associated data, an operating system including a kernel, and device drivers; a persistent storage device 903, such as a hard drive or flash drive for persistently storing programs and data; computer-readable media drives 904 that are tangible storage means that do not include a transitory, propagating signal, such as a floppy, CD-ROM, or DVD drive, for reading programs and data stored on a computer-readable medium; and a network connection 905 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations and having various components.

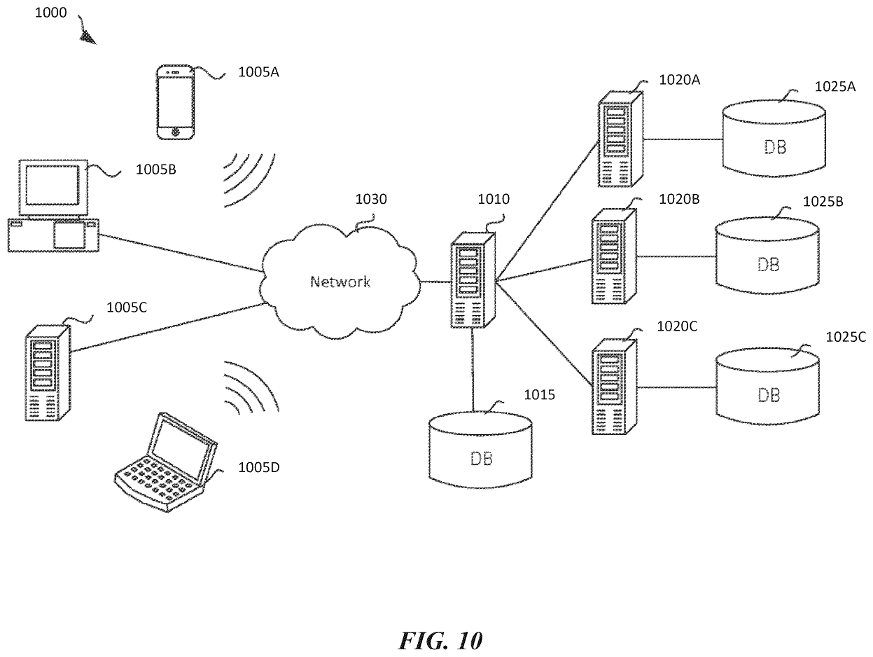

FIG. 10 is a system diagram illustrating an example of a computing environment in which the disclosed system operates in some embodiments. In some embodiments, environment 1000 includes one or more client computing devices 1005A-D, examples of which can host the system 100. Client computing devices 1005 operate in a networked environment using logical connections through network 1030 to one or more remote computers, such as a server computing device.

In some embodiments, server 1010 is an edge server which receives client requests and coordinates fulfillment of those requests through other servers, such as servers 1020A-C. In some embodiments, server computing devices 1010 and 1020 comprise computing systems, such as the system 100. Though each server computing device 1010 and 1020 is displayed logically as a single server, server computing devices can each be a distributed computing environment encompassing multiple computing devices located at the same or at geographically disparate physical locations. In some embodiments, each server 1020 corresponds to a group of servers.

Client computing devices 1005 and server computing devices 1010 and 1020 can each act as a server or client to other server or client devices. In some embodiments, servers (1010, 1020A-C) connect to a corresponding database (1015, 1025A-C). As discussed above, each server 1020 can correspond to a group of servers, and each of these servers can share a database or can have its own database. Databases 1015 and 1025 warehouse (e.g., store) information such as home information, recent sales, home attributes, and so on. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN) but can also be other wired or wireless networks. In some embodiments, network 1030 is the Internet or some other public or private network. Client computing devices 1005 are connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

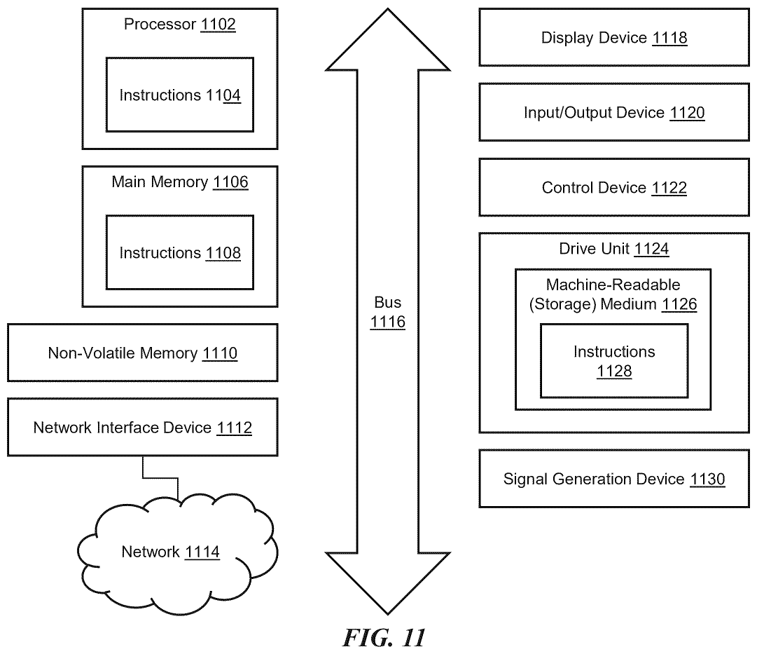

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a video display device 1118, an input/output device 1120, a control device 1122 (e.g., keyboard and pointing device), a drive unit 1124 that includes a machine-readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computing system 1100 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1100. In some implementations, the computer system 1100 can be an embedded computer system, a system-on-chip (SOC), a single-board computer system (SBC), or a distributed system such as a mesh of computer systems, or it can include one or more cloud components in one or more networks. Where appropriate, one or more computer systems 1100 can perform operations in real time, in near real time, or in batch mode.

The network interface device 1112 enables the computing system 1100 to mediate data in a network 1114 with an entity that is external to the computing system 1100 through any communication protocol supported by the computing system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computing system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computing system 1100 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the technology. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed herein, unless the above Detailed Description explicitly defines such terms. Accordingly, the actual scope of the technology encompasses not only the disclosed examples but also all equivalent ways of practicing or implementing the technology under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the technology can be modified to employ the systems, functions, and concepts of the various references described above to provide yet further implementations of the technology.

To reduce the number of claims, certain implementations are presented below in certain claim forms, but the applicant contemplates various aspects of an technology in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer implemented method for generation of a visualization based on location correlated agricultural asset data, the method comprising:
receiving, by a computer system, agricultural data, wherein the agricultural data comprises data relating to a plurality of assets and a custom geographical framework, wherein the computer system comprises a processor and a memory;
automatically generating, by the computer system, at least one location index corresponding to each asset of the plurality of assets via using the processor to calculate a geospatial intersection between defined geospatial boundaries of the asset and a hierarchical set of administrative and/or geospatial designations defined by the custom geographical framework stored in the memory associated;
generating, by the computer system, at least one meta-data table based on the received agricultural data;
automatically generating, by the computer system, one or more recommendations for validation rules in connection with the agricultural data, the one or more recommendations based on the at least one meta-data table;
validating and normalizing, by the computer system, the agricultural data into one or more normalized asset data tables using the one or more validation rules, wherein the one or more normalized asset data tables comprise: an asset identifier;
the at least one location index;
one or more columns comprising asset information corresponding to the respective asset; and
a plurality of unique identifier fields corresponding to each asset identifier of the plurality of assets, each unique identifier field of the plurality of unique identifier fields linking the one or more normalized asset data tables to a category specific table comprising a plurality of entries corresponding to an associated asset of the plurality of assets, wherein each of the plurality of entries is weighted by an automatically generated weighting mechanism based on an objective criteria of the associate asset;
storing the one or more normalized asset data tables in one or more databases;
generating, by the computer system, an analysis data table, wherein the analysis data table comprises a combination of a normalized asset data table of the one or more normalized asset data tables and a selected data table stored in the one or more databases, wherein the normalized asset data table and the selected data table are linked by the at least one location index;
generating for display, by the computer system, a query interface, wherein the query interface is configured to receive a natural language query;
receiving, by the computer system via the query interface, the natural language query; and
generating, by the computer system, in response to the natural language query, a visualization based at least in part on the analysis data table.

2. The method of claim 1 wherein the agricultural data is received via an import mechanism, the import mechanism in communication with a user interface displayed on a user computer system.

3. The method of claim 1 wherein the agricultural data is imported via an application programming interface (API), wherein the API comprises a Representational State Transfer (REST) API.

4. (canceled)

5. The method of claim 1 wherein the one or more normalized asset data tables further comprise:
at least one user provided category.

6. The method of claim 1 wherein the one or more columns comprising asset information comprise full geospatial data a geospatial boundary of each asset of the plurality of assets.

7. The method of claim 1 wherein the one or more normalized asset data tables further comprise:
at least one alternate identifier corresponding to the respective asset of the plurality of assets, wherein the alternate identifier corresponds an identifier of the respective asset in a third-party application.

8. The method of claim 1 wherein the one or more normalized asset data tables further comprise at least one temporal data column implemented as a Boolean value.

9. The method of claim 1 wherein the one or more normalized asset data tables further comprise a knowledge date corresponding to each asset of the plurality of assets.

10. (canceled)

11. (canceled)

12. The method of claim 1, further comprising displaying, by the computer system, the visualization on a user device.

13. The method of claim 12 wherein the visualization is displayed via a user interface integrated in a mobile application, a web browser, or a spreadsheet application.

14. A system, comprising:
at least one hardware processor; and
at least one non-transitory memory storing instructions that, when executed by the at least one hardware processor, cause the system to:
receive agricultural data, wherein the agricultural data comprises data relating to a plurality of assets and a custom geographical framework;
automatically generate at least one location index corresponding to each asset of the plurality of assets via the at least one hardware processor to calculate a geospatial intersection between defined geospatial boundaries of the asset and a hierarchical set of administrative and/or geospatial designations defined by the custom geographical framework stored in memory;
automatically generate at least one meta-data table based on the received agricultural data;
generate one or more recommendations for validation rules in connection with the agricultural data, the one or more recommendations based on the at least one meta-data table;
validate and normalize the agricultural data into one or more normalized asset data tables using the one or more validation rules, wherein the one or more normalized asset data tables comprise: an asset identifier;
the at least one location index;
one or more columns comprising asset information corresponding to the respective asset; and
a plurality of unique identifier fields corresponding to each asset identifier of the plurality of assets, each unique identifier field of the plurality of unique identifier fields linking the one or more normalized asset data tables to a category specific table comprising a plurality of entries corresponding to an associated asset of the plurality of assets, wherein each of the plurality of entries is weighted by an automatically generated weighting mechanism based on an objective criteria of the associate asset;
store the one or more normalized asset data tables in one or more databases;
generate an analysis data table, wherein the analysis data table comprises a combination of a normalized asset data table of the one or more normalized asset data tables and a selected data table stored in the one or more databases, wherein the normalized asset data table and the selected data table are linked by the at least one location index;
generate for display a query interface, wherein the query interface is configured to receive a natural language query;
receive, via the query interface, the natural language query; and
generate a visualization based at least in part on the analysis data table.

15. The system of claim 14 wherein the agricultural data is received via an import mechanism, the import mechanism in communication with a user interface displayed on a user computer system.

16. The system of claim 14 wherein the agricultural data is imported via an application programming interface (API), and wherein the API comprises a Representational State Transfer (REST) API.

17. (canceled)

18. The system of claim 14 wherein the system is further caused to display the visualization on a user device.

19. The system of claim 18 wherein the visualization is displayed via a user interface integrated in a spreadsheet application, a mobile application and/or a web browser.

20. A non-transitory, computer-readable storage medium comprising instructions recorded thereon, wherein the instructions, when executed by at least one data processor of a system, cause the system to:
receive agricultural data, wherein the agricultural data comprises data relating to a plurality of assets and a custom geographical framework;
automatically generate at least one location index corresponding to each asset of the plurality of assets via the at least one data processor to calculate a geospatial intersection between defined geospatial boundaries of the asset and a hierarchical set of administrative and/or geospatial designations defined by the custom geographical framework stored in memory;
automatically generate at least one meta-data table based on the received agricultural data;
generate one or more recommendations for validation rules in connection with the agricultural data, the one or more recommendations based on the at least one meta-data table;
validate and normalize the agricultural data into one or more normalized asset data tables using the one or more validation rules, wherein the one or more normalized asset data tables comprise: an asset identifier;
the at least one location index;
one or more columns comprising asset information corresponding to the respective asset; and
a plurality of unique identifier fields corresponding to each asset identifier of the plurality of assets, each unique identifier field of the plurality of unique identifier fields linking the one or more normalized asset data tables to a category specific table comprising a plurality of entries corresponding to an associated asset of the plurality of assets, wherein each of the plurality of entries is weighted by an automatically generated weighting mechanism based on an objective criteria of the associate asset;
store the one or more normalized asset data tables in one or more databases;
generate an analysis data table, wherein the analysis data table comprises a combination of a normalized asset data table of the one or more normalized asset data tables and a selected data table stored in the one or more databases, wherein the normalized asset data table and the selected data table are linked by the at least one location index;
generate for display a query interface, wherein the query interface is configured to receive a natural language query;
receive, via the query interface, the natural language query; and
generate a visualization based at least in part on the analysis data table.
